(19) United States
(12) Patent Application Publication
(10) Pub. No.: US 2014/0109582 A1
(43) Pub. Date: Apr. 24, 2014

(54) SELF-STABILIZED MICROMIXER

(71) Applicant: GENERAL ELECTRIC COMPANY, Schenectady, NY (US)

(72) Inventors: Borys SHERSHNYOV, Moscow (RU); Leonid ZVEDENUK, Moscow (RU)

(73) Assignee: General Electric Company, Schenectady, NY (US)

(21) Appl. No.: 13/658,675

(22) Filed: Oct. 23, 2012

(51) Int. Cl. F02C 7/22; F23R 3/28

(52) U.S. Cl. 60/737

(57) ABSTRACT

A micromixer of a premixer includes a plurality of enhanced minitubes and a plurality of unenhanced minitubes, both of which are arranged to deliver a premixed mixture of fuel and oxidizer to a combustion zone of a combustor. Both the enhanced and unenhanced minitubes are commonly bundled so as to function as a single fuel nozzle of the premixer. Each enhanced minitube includes a turbulence enhancer arranged to disturb a flow of the premixed mixture at the exit of thereof. This intensifies the turbulent jet interaction of the fuel and oxidizer mixture as the mixture suddenly expands from the enhanced minitube, thus providing aerodynamic combustion stabilization.

One or more aspects of the present invention relate to a premixer of a combustor for a gas turbine system. In particular, the one or more aspects relate to self-stabilized micromixers of a premixer.

### BACKGROUND OF THE INVENTION

In many gas turbines, premixers are used to premix compressed air with fuel and to deliver the fuel and air mixture to a combustion zone in the combustor for combustion. Lean premix dry low-NOx combustors are prevalent today. Such combustors operate in a premix lean mode (greater air to fuel ratio than stochiometric). Operating in premix lean mode provide benefits such as reduced NOx emissions. But operating in lean mode also means that lean blowouts (LBO) are of greater concern than before, and steps should be taken to minimize or prevent LBOs from occurring.

Micromixers are increasingly being developed for use in the dry low-NOx combustors to premix fuel and air. In a typical micromixer, a bundle of commonly attached tubes (i.e., mini-tubes) function as a single nozzle to deliver fuel and air mixture to the combustion zone. Micromixers provide many benefits such as reduction in NOx emissions and combustion noise with respect to other lean premix dry low-NOx fuel nozzle designs.

However, the micromixers are also more susceptible to LBO than other fuel nozzle designs. In many fuel nozzle designs (e.g., axial burners), flame stabilization is provided (at least in part) through recirculation zones. But in conventional micromixers, the recirculation zones are reduced or non-existent, and flame stabilization is achieved through jet interaction in high turbulence regions of sudden expansion in comparison to other fuel nozzle. This is because, where there are swirled flows or flow structures, they are typically smaller in scale and there is no conventional recirculation of hot combustion products into premixed flow. Micromixers generally have poor turndown capability. Turndown capability refers to an ability to operate the gas turbine at part load with emissions compliance. CO emissions can be high at part loads in combustors with conventional micromixers, where combustors with axial burners do not have any CO. Also lean blow-out may occur at 60-70% load instead of at 30-40%. It is seen that conventional micromixers have small margins to LBO and high CO emissions at part loads.

### BRIEF SUMMARY OF THE INVENTION

A non-limiting aspect of the present invention relates to a micromixer of a premixer of a gas turbine system. The micromixer is arranged to deliver a premixed mixture of fuel and oxidizer to a combustion zone of a combustor. The micromixer comprises a plurality of enhanced minitubes arranged to deliver the mixture of fuel and oxidizer to the combustion zone. The micromixer also comprises a plurality of unenhanced minitubes arranged to deliver the mixture to the combustion zone. Both the enhanced and unenhanced minitubes are commonly bundled so as to function as a single fuel nozzle of the premixer. Also, each enhanced minitube comprises one or more turbulence enhancers arranged to disturb a flow of the mixture as the mixture exits the enhanced minitube.

Another non-limiting aspect of the present invention relates to a premixer of a gas turbine system. The premixer is arranged to deliver a premixed mixture of fuel and oxidizer to a combustion zone of a combustor for combustion. The premixer comprises at least one micromixer on a face of the premixer. The micromixer comprises a plurality of enhanced minitubes arranged to deliver the mixture of fuel and oxidizer to the combustion zone. The micromixer also comprises a plurality of unenhanced minitubes arranged to deliver the mixture to the combustion zone. Both the enhanced and unenhanced minitubes are commonly bundled so as to function as a single fuel nozzle of the premixer. Also, each enhanced minitube comprises one or more turbulence enhancers arranged to disturb a flow of the mixture as the mixture exits the enhanced minitube.

The invention will now be described in greater detail in connection with the drawings identified below.

### BRIEF DESCRIPTION OF THE DRAWINGS

These and other features of the present invention will be better understood through the following detailed description of example embodiments in conjunction with the accompanying drawings, in which:

FIG. 1 illustrates a micromixer according to an embodiment of the present invention;

FIG. 2 illustrates a first embodiment of an enhanced minitube according to the present invention;

FIG. 3 illustrates a front perspective view of the first embodiment of the enhanced minitube;

FIG. 4 illustrates a second embodiment of an enhanced minitube according to the present invention;

FIG. 5 illustrates a front perspective view of the second embodiment of the enhanced minitube;

FIG. 6 illustrates a third embodiment of an enhanced minitube according to the present invention;

FIG. 7 illustrates a front perspective view of the third embodiment of the enhanced minitube;

FIG. 8 illustrates a fourth embodiment of an enhanced minitube according to the present invention;

FIG. 9 illustrates a front perspective view of the fourth embodiment of the enhanced minitube;

FIG. 10 illustrates a premixer according to an embodiment of the present invention;

### DETAILED DESCRIPTION OF THE INVENTION

Novel micromixers and premixer for a combustor of a gas turbine system are described. Compared to conventional micromixers, the novel micromixers have sufficient LBO margins at leaner fuel/air mixtures than non-enhanced/conventional micromixers. Also at part loads, the CO emission can be reduced.

As indicated above, conventional micromixers are more susceptible to LBO and higher CO emissions at part loads relative to other types of combustor fuel nozzle designs. At part loads, the conventional micromixers have poor turndown capability. The novel micromixer addresses these and other problems of conventional premixer and micromixer designs. Broadly, combustion stability and lean LBO capability are improved through using various ways to achieve aerodynamic combustion stabilization (flame anchoring) arranged in a number of micromixer tubes and through passive uneven fuel distribution between tubes with stabilization elements. The inventive micromixers and premixer embodiments extend turndown capabilities and reduce CO emissions, especially at part loads which are desirable.

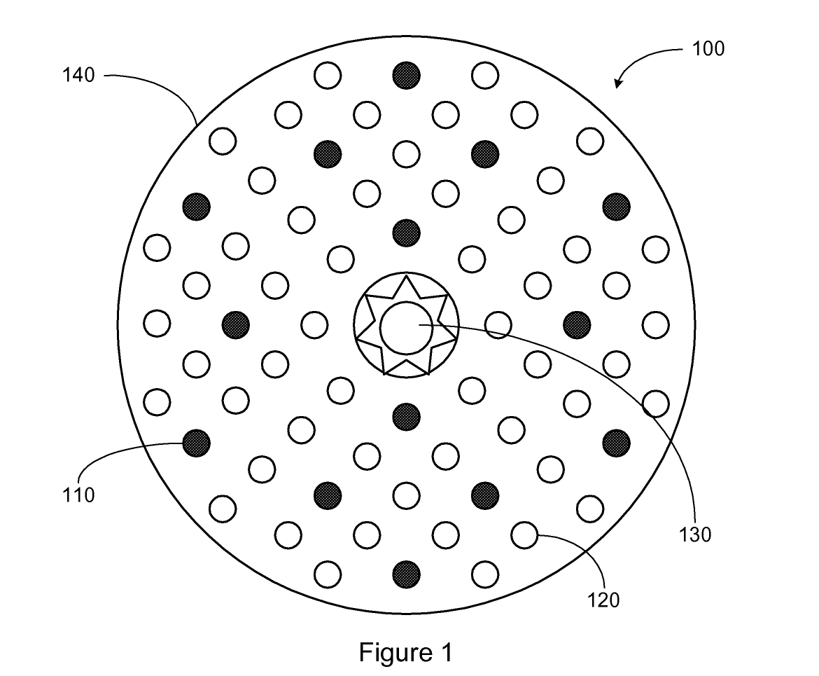

FIG. 1 illustrates a micromixer 100 according to an embodiment of the present invention. The micromixer 100 includes a plurality of enhanced minitubes 110 shown as filled circles and a plurality of unenhanced minitubes 120 shown as unfilled circles. As will be demonstrated below, each enhanced minitube 110 included one or more turbulence enhancers that disturb the premixed mixture of fuel and oxidizer (e.g., air) at the exit of the enhanced minitube 110. The disturbance intensifies the turbulent jet interaction of the fuel and oxidizer mixture as the mixture suddenly expands from the enhanced minitube 110, thus providing aerodynamic combustion stabilization (flame anchoring). Also, having unenhanced minitubes 120 distributed along with the enhanced minitubes 110 provide further flame stabilization.

Optionally, the micromixer 100 may also include an optional resonator 130. The resonator 130 may serve as an additional flame stabilizer. In addition to or instead of the resonator 130, a center fuel nozzle, a low temperature plasma source, etc. may also serve as sources of additional flame stabilization.

The micromixer 100 includes an enclosure 140 that surround the enhanced and unenhanced minitubes 110, 120 as well as the optional resonator 130. The enhanced and unenhanced minitubes 110, 120 surrounded by the enclosure 140 are commonly bundled such that the bundled minitubes 110, 120 function as a single fuel nozzle.

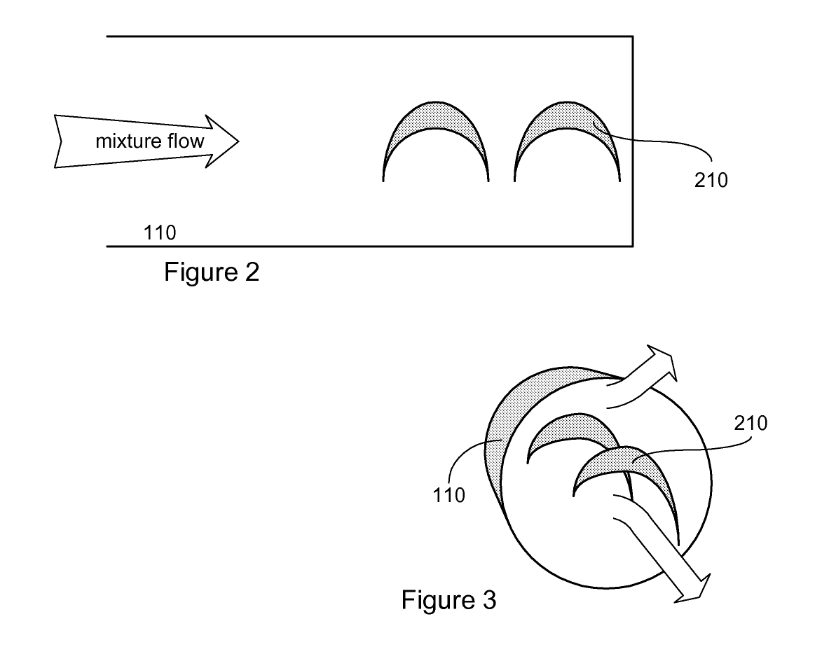

FIG. 2 illustrates a first embodiment of an enhanced minitube 110 according to the present invention, and FIG. 3 illustrates a front perspective view of the first embodiment. As seen, the enhanced minitube 110 of the first embodiment includes one or more twisted bands 210 as the turbulence enhancers. The twisted bands 210, which can have arbitrary geometric features, are located in the enhanced minitube 110 at or near where the mixture flow exits. The twisted bands 210 disturb the flow of the mixture of fuel and oxidizer as indicated by the arrows. As illustrated in FIG. 2, the direction of the mixture flow is assumed to be from left to right as indicated by the arrow. In particular, the twisted bands 210 disturb the premixed flow at the exit of the enhanced minitube 110 as illustrated by the arrows in FIG. 3.

The twisted bands 210 improve flame stabilization through providing disturbance of the mixture. The disturbance enhances flame stabilization through providing enhanced jet interaction due to turbulence intensification, and creating a flow recirculation at the exit of the enhanced minitube 110. In addition, CO emissions are reduced, particularly at part loads.

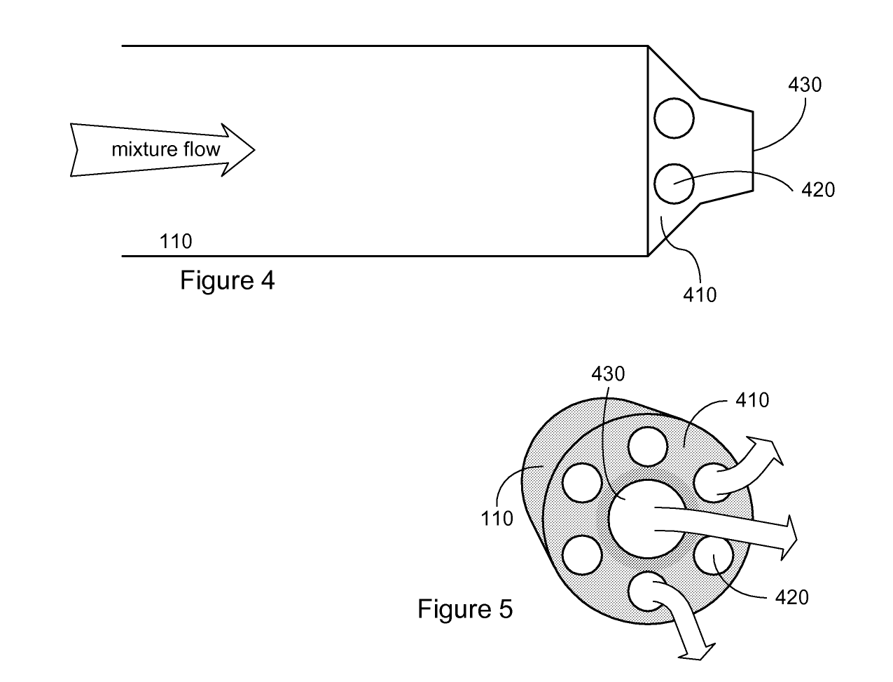

FIG. 4 illustrates a second embodiment of an enhanced minitube 110 according to the present invention, and FIG. 5 illustrates a front perspective view of the second embodiment. As seen, the enhanced minitube 110 of the second embodiment includes a fitting 410 attached to the exit end of the minitube 110. The fitting 410, which serves as the turbulence enhancer in this embodiment, has peripheral orifices 420 and a central orifice 430. The flow of the mixture is disturbed as the mixture flows through the peripheral and central orifices 420, 430 as indicated by the arrows in FIG. 5, and the interaction between the enhanced and unenhanced jets is intensified.

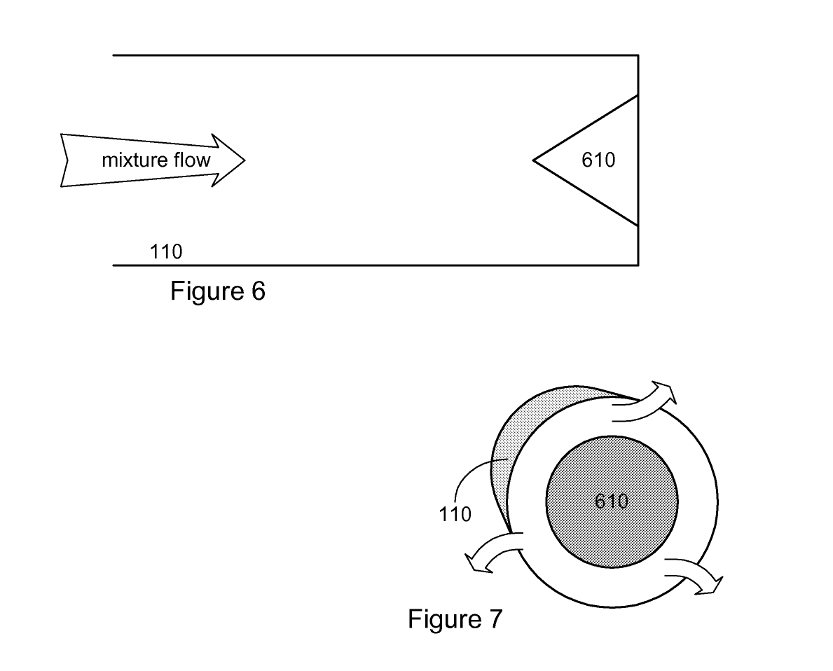

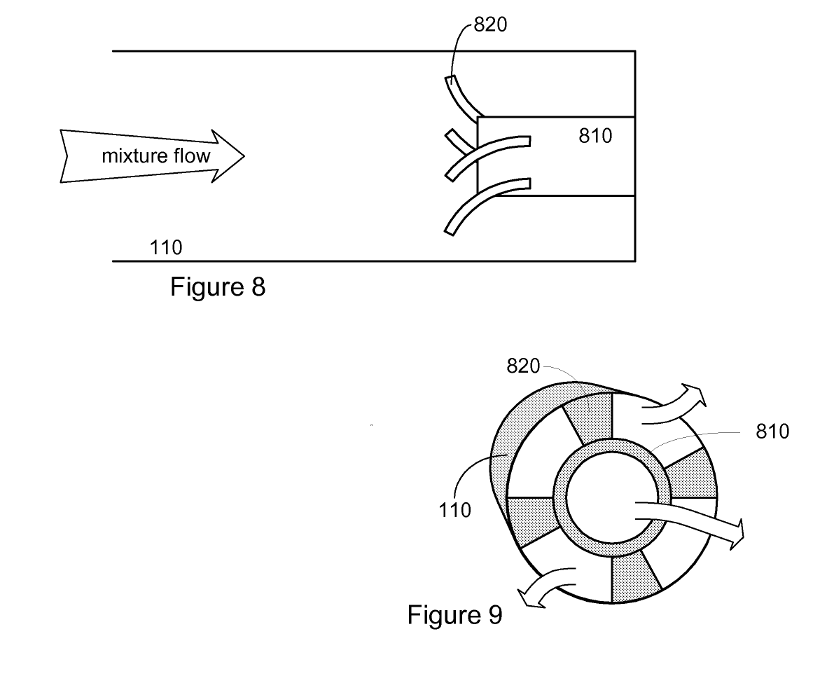

FIG. 6 illustrates a third embodiment of an enhanced minitube according to the present invention, and FIG. 7 illustrates a front perspective view of the third embodiment. As seen, the enhanced minitube 110 of the third embodiment includes a conical bluff body anchor 610 serving as the turbulence enhancer. The bluff body anchor 610 is not limited to the conical shape. The flow of the mixture is disturbed as the mixture flows around the bluff body anchor 610 as indicated by the arrows in FIG. 7. As the mixture flow separates from the bluff body anchor 610, its turbulence is intensified.

FIG. 8 illustrates a fourth embodiment of an enhanced minitube according to the present invention, and FIG. 9 illustrates a front perspective view of the third embodiment. As seen, the enhanced minitube 110 of the fourth embodiment includes a microswirler 810 with a plurality of microvanes 820. The flow of the mixture is disturbed by the microswirler 810 as indicated by the arrows in FIG. 9.

Referring back to FIG. 1, there can be any number of enhanced and unenhanced minitubes 110, 120. Also, a ratio of the number of enhanced minitubes 110 relative to the number of unenhanced minitubes is not particularly limited. While the ratio is not necessarily limited, it is preferred that the ratio be less than one, i.e., the preference is that the enhanced minitubes 110 make up the minority of the minitubes. For example, the ratio of the number of enhanced minitubes 110 to the number of unenhanced minitubes can substantially range between 1:5 and 1:7. One reason that ratio is preferred to be less than is the pressure drop that can in occur due to the turbulence enhancers. Excessive pressure drops can have undesirable effects on efficiency. By having the enhanced minitubes 110 making up the minority, overall pressure drops can be kept within tolerable limits. Another reason is that the enhanced minitubes 110 are more costly than the unenhanced minitubes 120. Note that as these issues are addressed, the ratio can be increased.

While not required, it is preferred that the enhanced and unenhanced minitubes 110, 120 be arranged such that one or more enhanced minitubes 110 are adjacent to no other enhanced minitube 110. Most preferably, no enhanced minitube 110 is adjacent to another enhanced minitube 110.

One natural result of using turbulence enhancers is that the enhanced minitube 110 flows less oxidizer, e.g., air, than the unenhanced minitube 110 due to a higher pressure loss in the enhanced minitube 110. If the fuel supply is organized such that there is substantially the same amount of fuel going to all the minitubes (enhanced and unenhanced), the enhanced minitubes 110 will naturally have higher fuel-to-oxidizer ratio. Thus, in one embodiment, the differential in the mixture flow between the enhanced and unenhanced minitubes 110, 120 can be taken into account when providing the fuel to the minitubes 110, 120 such that the overall fuel-to-oxidizer ratio is within a desirable predetermined range.

In another aspect, the fuel flow can be divided between enhanced and unenhanced minitubes 110, 120, and the desirable fuel-to-oxidizer ratio can be achieved. In one embodiment, the minitubes 110, 120 can be arranged such that the fuel-to-oxidizer ratios flowing through at least one enhanced minitube 110 and through at least one unenhanced minitube 120 are substantially equal. Of course, it can be desirable have uniform fuel-to-oxidizer ratio flowing through as many of the minitubes 110, 120 as possible.

Note that even if the fuel flow can be divided, there may be occasions where it may be beneficial to have different fuel-to-oxidizer ratios between the enhanced and unenhanced minitubes 110, 120. Thus in another embodiment, the minitubes 110, 120 are arranged such that the fuel-to-oxidizer ratios of the enhanced minitubes 110 are adaptable, or the fuel-to-oxidizer ratios of the unenhanced minitubes 120 are adaptable, or both are adaptable.

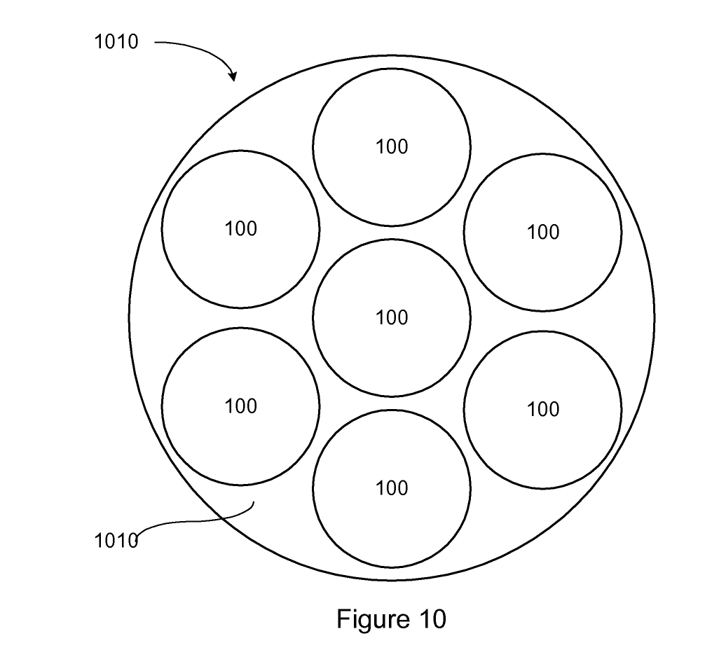

FIG. 10 illustrates a premixer 1000 according to an embodiment of the present invention. The premixer 1000 is arranged to deliver a mixture of fuel and oxidizer to the combustion zone of a combustor for combustion. In one aspect, the premixer 1000 includes a micromixer bundle installed in a combustor cap. As seen in FIG. 10, the premixer 1000 includes one or more micromixers 100. At least one of the micromixers 100 includes a plurality of enhanced and unenhanced minitubes 110, 120 as described above.

Among the advantages of the inventive micromixer and a premixer incorporating the micromixer include enhanced LBO margin and a reduction of CO emissions at part loads.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A micromixer of a premixer of a gas turbine system, the micromixer arranged to deliver a premixed mixture of fuel and oxidizer to a combustion zone of a combustor, the micromixer comprising:
a plurality of enhanced minitubes arranged to deliver the mixture to the combustion zone; and
a plurality of unenhanced minitubes arranged to deliver the mixture to the combustion zone;
wherein both the enhanced and unenhanced minitubes are commonly bundled so as to function as a single fuel nozzle of the premixer, and
wherein each enhanced minitube comprises one or more turbulence enhancers arranged to disturb a flow of the mixture as the mixture exits the enhanced minitubes.

2. The micromixer of claim 1, further comprising an enclosure arranged to surround and commonly bundle the enhanced and unenhanced minitubes such that the enhanced and unenhanced minitubes function as the single fuel nozzle.

3. The micromixer of claim 1, wherein the turbulence enhancer is any one of a twisted band, a fitting, a bluff body anchor and a microswirler.

4. The micromixer of claim 1, wherein a number of enhanced minitubes is less than a number of unenhanced minitubes.

5. The micromixer of claim 4, wherein the enhanced minitubes are distributed such that at least one enhanced minitube is adjacent to no other enhanced minitube.

6. The micromixer of claim 5, wherein no enhanced minitube is adjacent to another enhanced minitube.

7. The micromixer of claim 1, wherein the enhanced and unenhanced minitubes are arranged such that an overall fuel-to-oxidizer ratio of the mixture flowing through the enhanced and unenhanced minitubes is within a predetermined range.

8. The micromixer of claim 1, wherein the enhanced and unenhanced minitubes are arranged such that
a fuel-to-oxidizer ratio of the mixture flowing through at least one at least one enhanced minitube is adaptable, or
a fuel-to-oxidizer ratio of the mixture flowing through at least one at least one unenhanced minitube is adaptable, or
both.

9. The micromixer of claim 1, wherein at least one enhanced minitube and at least one unenhanced minitube are arranged such that fuel-to-oxidizer ratios of the mixture flowing through the enhanced minitube and through the unenhanced minitube are substantially equal.

10. A premixer of a gas turbine system, the premixer arranged to deliver a premixed mixture of fuel and oxidizer to a combustion zone of a combustor for combustion, the premixer comprising:
at least one micromixer on a face of the premixer, wherein the micromixer comprises:
a plurality of enhanced minitubes arranged to deliver the mixture to the combustion zone; and
a plurality of unenhanced minitubes arranged to deliver the mixture to the combustion zone;
wherein both the enhanced and unenhanced minitubes are commonly bundled so as to function as a single fuel nozzle of the premixer, and
wherein each enhanced minitube comprises one or more turbulence enhancers arranged to disturb a flow of the mixture as the mixture exits the enhanced minitubes.

11. The premixer of claim 10, further comprising an enclosure arranged to surround and commonly bundle the enhanced and unenhanced minitubes such that the enhanced and unenhanced minitubes function as the single fuel nozzle.

12. The premixer of claim 10, wherein the turbulence enhancer is any one of a twisted band, a fitting, a bluff body anchor and a microswirler.

13. The premixer of claim 10, wherein a number of enhanced minitubes is less than a number of unenhanced minitubes.

14. The premixer of claim 13, wherein the enhanced minitubes are distributed such that at least one enhanced minitube is adjacent to no other enhanced minitube.

15. The premixer of claim 14, wherein no enhanced minitube is adjacent to another enhanced minitube.

16. The premixer of claim 10, wherein the enhanced and unenhanced minitubes are arranged such that an overall fuel-to-oxidizer ratio of the mixture flowing through the enhanced and unenhanced minitubes is within a predetermined range.

17. The premixer of claim 10, wherein the enhanced and unenhanced minitubes are arranged such that
a fuel-to-oxidizer ratio of the mixture flowing through at least one at least one enhanced minitube is adaptable, or
a fuel-to-oxidizer ratio of the mixture flowing through at least one at least one unenhanced minitube is adaptable, or
both.

18. The premixer of claim 10, wherein at least one enhanced minitube and at least one unenhanced minitube are arranged such that fuel-to-oxidizer ratios of the mixture flowing through the enhanced minitube and through the unenhanced minitube are substantially equal.
